(19) United States
(12) Patent Application Publication
(10) Pub. No.: US 2025/0173661 A1
(43) Pub. Date: May 29, 2025

(54) SYSTEM AND METHOD FOR IDENTIFYING NATURAL ALTERNATIVES TO SYNTHETIC ADDITIVES IN FOODS

(71) Applicant: The Live Green Group, Inc., Middletown, DE (US)

(72) Inventors: Sasikanth Chemalamudi, San Fernando (CL); Priyanka Srinivas, San Fernando (CL)

(21) Appl. No.: 18/837,216

(22) PCT Filed: Feb. 4, 2023
(86) PCT No.: PCT/IB2023/051007

§ 371 Date: Aug. 9, 2024

Related U.S. Application Data
(60) Provisional application No. 63/308,612, filed on Feb. 10, 2022.

(30) Foreign Application Priority Data
Feb. 10, 2022 (US) 63/308612
Feb. 4, 2023 (WO) PCT/IB2023/051007

(51) Int. Cl. G06Q 10/0637; A23L 33/10; G06N 5/022; G06N 20/00

(52) U.S. Cl. CPC G06Q 10/06375; A23L 33/10; G06N 5/022; G06N 20/00

(57) ABSTRACT

A method of modifying a food item to contain plant-based ingredients includes identifying plant-based substances to replace an ingredient of the food item. The plant-based substances are clustered, via a machine learning model, into a plurality of clusters according to an objective based on properties of the plant-based substances. The plant-based substances of a selected cluster are classified into a plurality of classes, via a machine learning classifier, based on the objective and the properties of the plant-based substances of the selected cluster. A score is determined for each plant-based substance of a selected class based on metrics. A plant-based substance is determined based on the score to produce a modified food item with the determined plant-based substance replacing the ingredient.

### BACKGROUND

### Priority Paragraph

This application claims priority to the U.S. provisional patent application No. 63/308,612, filed on Feb. 10, 2022 and PCT provisional patent application no.: PCT/IB2023/051007, filed on Feb. 4, 2023, titled “SYSTEM AND METHOD FOR IDENTIFYING NATURAL ALTERNATIVES TO SYNTHETIC ADDITIVES IN FOODS” and is incorporated herein by reference.

### TECHNICAL FIELD

Present invention embodiments relate to technologies for modifying foods, and more specifically, to technologies for identifying plant-based or other natural alternatives to synthetic additives in foods in order to produce modified foods with the plant-based or other natural alternatives.

### DISCUSSION OF THE RELATED ART

Additives are substances that are added to food during the process of manufacture. Additives may be added to food before or during delivery to the consumer, and are used for many purposes, such as improving the taste, texture, appearance, and shelf-life of food.

Current food manufacturing processes are based on trials using ingredients that have been determined from existing knowledge and human experience. However, these approaches of identifying ingredients and shortlisting and creating formulations is limited in nature, laborious, time-consuming, and highly error prone.

### SUMMARY

According to one embodiment of the present invention, a food item is modified to contain plant-based ingredients. Plant-based substances are identified, via a computer, to replace an ingredient of the food item. The plant-based substances are clustered, via a machine learning model on a computer, into a plurality of clusters according to a desired objective and based on properties of the plant-based substances. The plant-based substances of a selected cluster are classified into a plurality of classes, via a machine learning classifier on a computer, based on the desired objective and the properties of the plant-based substances of the selected cluster. A score is determined, via a computer, for each plant-based substance of a selected class based on metrics. A plant-based substance is determined, via a computer, based on the score to produce a modified food item with the determined plant-based substance replacing the ingredient.

In some embodiments, plant-based substances to replace an ingredient of the food item are identified by constructing a knowledge graph that includes nodes representing plant-based substances, a set of features associated with each node, and edges defining relationships between the nodes. Utilizing a knowledge graph in this manner can be advantageous in that it may allow multiple features to be analyzed simultaneously.

In some embodiments, the set of features associated with each node of the knowledge graph includes respective functionalities of the plant-based substances.

In some embodiments, the features of the plant-based substances used for clustering include features from the knowledge graph.

In some embodiments, the features of the plant-based substances used for clustering include one or more selected from the group consisting of functionality, physicochemical characteristics, mechanical properties, chemical and molecular descriptors, sensorial characteristics, nutritional information, taxonomical information, bioactivity, and attributes from ancestral wisdom. For example, by combining features from modern science and attributes from ancestral wisdom, new combinations can be identified with distinct composition to achieve targeted outcomes.

In some embodiments, each cluster in the plurality of clusters is associated with a level of the desired objective.

In some embodiments, the desired objective includes a functionality of the ingredient to be replaced.

In some embodiments, the machine learning model is an unsupervised machine learning model trained with a set of features associated with plant-based substances as an input.

In some embodiments, the classes correspond to a level of fitness for achieving the desired objective.

In some embodiments, the machine learning classifier is a supervised machine learning classifier trained using feature vectors of the plant-based substances as an input and known classes as an output.

In some embodiments, the machine learning classifier is trained with new features from clusters resulting from unsupervised operation of the machine learning model.

Training the machine learning classifier in this manner can be advantageous in that it may allow application of derived data that would otherwise not be available.

In some embodiments, the metrics are calculated based on the properties of the plant-based substances meeting the desired objective.

In some embodiments, the features of the plant-based substances for the machine learning model include attributes obtained from ancestral wisdom.

In some embodiments, the modified food item is produced by replacing the ingredient with the determined plant-based substance, testing the modified food item with respect to characteristics for the food item, obtaining feedback in response to the modified food item failing to satisfy the characteristics for the food item, and training at least one of the machine learning model and the machine learning classifier using the feedback.

Embodiments of the present invention include a method, system, and computer program product for modifying a food item to contain plant-based ingredients in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flow diagram of a manner of determining alternative plant-based substances for ingredients of a target food item according to an embodiment of the present invention.

FIG. 4 is a flowchart of an example manner of data collection for food items in accordance with an embodiment of the present invention.

FIG. 5 is an illustration of example data sources used for determining alternative plant-based substances according to an embodiment of the present invention.

FIG. 6 is a flowchart of an example manner of data collection used for determining alternative plant-based substances according to an embodiment of the present invention.

FIG. 7 is a flowchart of a manner of determining an alternative plant-based substance for a target food item according to an embodiment of the present invention.

FIG. 8 is a graphical illustration of example clusters of alternative plant-based substances for a target food item according to an embodiment of the present invention.

FIG. 9 is a flowchart of an example method of generating a recipe for making ice cream using selected natural alternative candidates, according to an embodiment of the present invention.

FIGS. 10A-10G are views illustrating various operations of determining the alternative plant-based substance for ice cream, according to an embodiment of the present invention.

### DETAILED DESCRIPTION

An embodiment of the present invention identifies plant-based or other natural alternatives to replace additives and animal ingredients in food by blending ancestral wisdom (or historical holistic information and/or practices) with biotechnology and artificial intelligence (AI)/machine learning (ML). The embodiment identifies and assigns functionality to a plant-based alternative based on taxonomy, molecular composition, physicochemical characteristics, mechanical properties, nutritional information, uses from ancestral wisdom, lab analysis, etc. The embodiment categorizes the plant-based alternatives according to various criteria, and assigns them individually, and as formulations derived from a combination of plant-based alternatives, to replace the additives and animal ingredients based on the category of the food. The recommendations for replacement are assigned a probability score to serve as inputs during food formulation design.

Current food manufacturing processes are based on trials using ingredients that have been determined from existing knowledge and human experience. These approaches of identifying ingredients and shortlisting and creating formulations is limited in nature, laborious, time-consuming, and highly error prone.

However, a present invention embodiment employs a data centric approach to creating formulations and alternatives to target ingredients by applying machine learning and statistical techniques to a growing database of plants, including plant properties and information synthesized from ancestral (or historical holistic) sciences (e.g., Ayurveda, etc.). The embodiment is able to create ingredient formulations and predict relevance to an application in a food product.

Although data driven approaches are outlined in drug discovery, most research in drug discovery is also based on structural modelling to obtain desired behavior. In stark contrast, present invention embodiments focus on functionalities of ingredients by analysis of various data points related to the properties, behavior, and composition of food ingredients.

An embodiment of the present invention utilizes a unique dataset created from categories of data including:
publicly available data sources (e.g., FDA, EFSA, FAO, USDA, etc.);
analyzed and synthesized data from the world wide web based on text mining and natural language processing (NLP) techniques (e.g., GPT, BERT, NER, etc.);
a database based on data collation, translation, and data processing of literature based on ancestral wisdom (or historical holistic practices) (e.g., Ayurveda, Sidha, Unani, Chinese Herbology, etc.) using optical character recognition (OCR), deep learning vision models, translation algorithms, and clustering and classification techniques;
datasets created through lab analysis, in-house research, information captured through various tools involving partnerships and crowd-sourcing; and
datasets generated in model development, lab trials, food science reviews and industry and consumer feedback.
   Any desired percentages of contribution may be utilized.

A present invention embodiment leverages learnings from both ancestral wisdom (e.g., historical holistic information and practices at least a decade or a century in age) and modern science. The conversion and application of ancestral wisdom is done via data cleaning, data transformation, and data-storage initiatives. The techniques are continuously evolving based on training models consuming research data and feedback loops from consumers and lab and production teams. The embodiment uses statistical, machine learning, and deep learning techniques to model data to predict functionalities of ingredients and formulations of ingredients, and assigns a matching score for any target additive based on the specific category of food.

The models of present invention embodiments are trained using data created and collated to represent an overall view of the ingredients. The datasets include:
functionality information (e.g. emulsification, stabilization, gelling properties, fat replacement properties, etc.);
physicochemical characteristics (e.g. pH, viscosity, moisture, density, etc.);
mechanical properties (e.g. adhesive strength, tensile strength, shear resistance, etc.);
chemical and molecular descriptors (e.g., bioactive compounds, molecular structure, phytonutrients, etc.);
sensorial characteristics (e.g., taste, smell, color, texture, mouthfeel, etc.);
nutritional information (e.g., macro/micronutrients, etc.);
taxonomical information;
bioactive compounds; and
ancestral wisdom (e.g., Ayurvedic, etc.).

A present invention embodiment employs various machine learning and deep learning models to cluster and classify information. Further, the embodiment uses neural networks to identify relationships between various captured data points and the functionality imparted. The embodiment extrapolates inferences to a combination of existing and new ingredients, and is able to identify and predict plant-based formulations to match the functionality of an additive or animal ingredient.

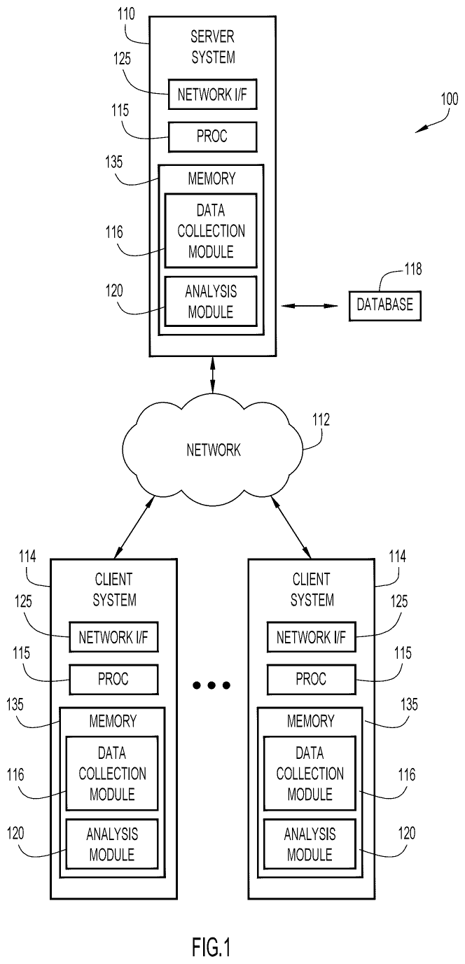

An example environment 100 for use with present invention embodiments is illustrated in FIG. 1. Specifically, the environment 100 includes one or more server systems 110, and one or more client or end-user systems 114. Server systems 110 and client systems 114 may be remote from each other and communicate over a network 112. The network may be implemented by any number of any suitable communications media (e.g., wide area network (WAN), local area network (LAN), Internet, Intranet, etc.). Alternatively, server systems 110 and client systems 114 may be local to each other, and communicate via any appropriate local communication medium (e.g., local area network (LAN), hardwire, wireless link, Intranet, etc.).

Client systems 114 enable users to submit requests to server systems 110 to determine alternative plant-based or other natural substances for ingredients of a target food item. The server systems include a data collection module 116 and an analysis module 120. The data collection module 116 collects data pertaining to food items and alternative plant-based or other natural substances. Analysis module 120 analyzes the collected information to determine alternative plant-based or other natural substances for ingredients of a target food item based on machine learning. For example, the analysis module 120 may determine a plant-based substance to be substituted for a meat-based ingredient of a target food item.

A database system 118 may store various information for the analysis (e.g., food item information, alternative substance information, etc.). Database system 118 stores information for various food items and for various plant-based or other natural substances. The database system may be implemented by any conventional or other database or storage unit, may be local to or remote from server systems 110 and client systems 114, and may communicate via any appropriate communication medium (e.g., local area network (LAN), wide area network (WAN), Internet, hardwire, wireless link, Intranet, etc.). The client systems 114 may present a graphical user (e.g., GUI, etc.) or other interface (e.g., command line prompts, menu screens, etc.) to solicit information from users pertaining to the desired request and analysis, and may provide reports including analysis results (e.g., alternative substance, amounts, properties, etc.).

Server systems 110 and client systems 114 may be implemented by any conventional or other computer systems preferably equipped with a display or monitor, a base, optional input devices (e.g., a keyboard, mouse or other input device), any commercially available software (e.g., server/communications software, browser/interface software, etc.), and any custom software of present invention embodiments (e.g., data collection module 116, analysis module 120, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Alternatively, one or more client systems 114 may determine alternative plant-based or other natural substances for ingredients of a target food item when operating as a stand-alone unit. In a stand-alone mode of operation, the client system stores or has access to the data (e.g., food item information, plant-based or other natural substance information, etc.), and includes data collection module 116 and analysis module 120. Data collection module 116 collects data pertaining to food items and alternative plant-based or other natural substances, while analysis module 120 determines alternative plant-based or other natural substances for ingredients of a target food item based on machine learning. The graphical user (e.g., GUI, etc.) or other interface (e.g., command line prompts, menu screens, etc.) solicits information from a corresponding user pertaining to the desired request and analysis, and may provide reports including analysis results (e.g., alternative substance, amounts, properties, etc.).

Data collection module 116 and analysis module 120 may include one or more modules or units to perform the various functions of present invention embodiments described below. The various modules (e.g., data collection module 116, data analysis module 120, etc.) may be implemented by any combination of any quantity of software and/or hardware modules or units, and may reside within memory 135 of the server and/or client systems for execution by a corresponding processor 115.

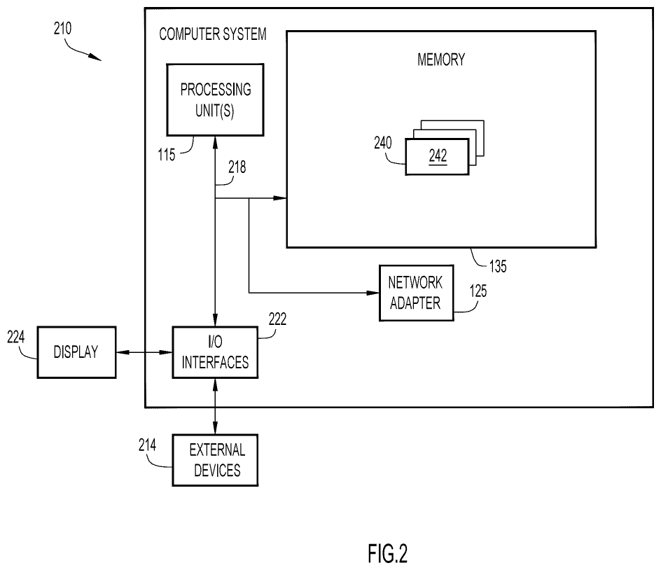

Referring now to FIG. 2, a schematic of an example of a computing device 210 of computing environment 100 (e.g., implementing server system 110 and/or client system 114) is shown. The computing device 210 is an example of a computing device for computing environment 100 and is capable of being implemented and/or performing any of the functionality set forth herein.

In computing device 210, there is a computer system 212 which is operational with numerous other general purpose or special purpose computing system environments or configurations. Examples of computing systems, environments, and/or configurations that may be suitable for use with computer system 212 include personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

As shown in FIG. 2, computer system 212 may include one or more processors or processing units 115, a system memory 135, and a bus 218 that couples various system components including system memory 135 to processor units 115. Bus 218 may be of any types of bus structures, including a memory bus or memory controller, a peripheral bus, an accelerated graphics port, and a processor or local bus using any of a variety of conventional or other bus architectures.

The system memory 135 of computer system 212 typically includes computer system readable media including volatile media, non-volatile media, removable media, and/or non-removable media. System memory 135 can include computer system readable media in the form of volatile memory (e.g., random access memory (RAM), cache memory, etc.). System memory 135 may further include other removable/non-removable, volatile/non-volatile computer system storage media. By way of example only, a storage system can be provided for reading from and writing to a nonremovable, non-volatile magnetic media. Further, a magnetic disk drive and/or an optical disk drive (e.g., CD-ROM, DVD-ROM or other optical media, etc.) can be connected to bus 218 by one or more data media interfaces. Memory 135 may include at least one program product having a set (e.g., at least one) of program modules that are configured to carry out the functions of embodiments of the invention.

Program/utility 240, having a set (at least one) of program modules 242 (e.g., data collection module 116, analysis module 120, etc.) may be stored in memory 135 as well as an operating system, one or more application programs, other program modules, and program data. These may include an implementation of a networking environment. Program modules 242 generally carry out the functions and/or methodologies of embodiments of the invention as described herein.

Computer system 212 may also communicate with one or more external devices 214 (e.g., a keyboard, a pointing device, a display 224, etc.), one or more devices that enable a user to interact with computer system 212, and/or any devices (e.g., network card, modem, etc.) that enable computer system 212 to communicate with one or more other computing devices. Such communication can occur via Input/Output (I/O) interfaces 222. Computer system 212 can communicate with one or more networks such as a local area network (LAN), a general wide area network (WAN), and/or a public network (e.g., the Internet) via network adapter 125. Network adapter 125 communicates with the other components of computer system 212 via bus 218.

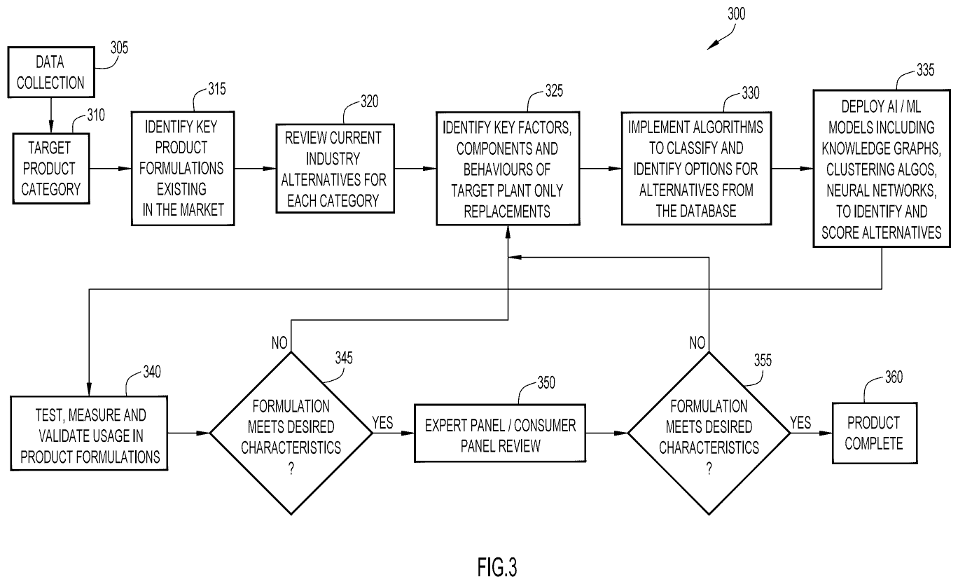

A method 300 of determining alternative plant-based substances for ingredients of a target food item (e.g., via data collection module 116, analysis module 120, and a server system 110 and/or a client system 114) according to an embodiment of the present invention is illustrated in FIG. 3. Initially, data collection module 116 collects information for food items and plant-based or other natural substances at operation 305. The information may be collected from various sources (e.g., web sites, product labels, various databases, articles, etc.) and processed as described below. The food item information and information for the plant-based substances are stored in database system 118.

A request may be received to determine alternative plant-based or other natural substances for one or more ingredients of a target food item. Analysis module 120 processes the request to determine the alternative plant-based substances to use in place of the one or more corresponding synthetic (or non-natural) ingredients (or target ingredients) of the target food item. In particular, a category of the target food item (e.g., ice cream, hamburgers, pancakes, etc.) and one or more corresponding ingredients desired to be replaced is determined at operation 310. This information may be received within a request from the user, and/or determined based on information in database system 118.

Key product formulations for the target food item are identified at operation 315, and current alternatives (e.g., including functionality) for each category are identified at operation 320. This information may be determined based on information in database system 118, and used to identify features (or properties or attributes) of the target ingredients for determination of alternative plant-based substances. For example, the ingredients to be replaced may be identified based on the formulations (or request from a user). The ingredients to be replaced are typically artificial additives, ultra-processed ingredients, and/or animal products. A scientific profile for the target ingredients may be produced indicating properties (e.g., scientific nomenclature, chemical properties, sensorial attributes, physicochemical properties, safety information, usage information, etc.). Public and private research information (e.g., usage, effects, applications, etc.) may be used and processed (e.g., tagging, named entity recognition (NER), sentiment analysis, other natural language processing (NLP), etc.) for classification, target ingredient definitions, and key attribute analysis.

Once the target ingredients have been processed, analysis module 120 identifies and analyzes key factors, components, and behaviors of alternative plant-based substances for the target ingredients at operation 325. This analysis may be based on information in database system 118, and used to identify and compare features (or properties or attributes) of the alternative plant-based substances to features of the target ingredients. For example, a scientific profile for the alternative plant-based substances may be produced indicating key metrics and/or properties (e.g., functional properties, physicochemical properties, mechanical properties, organoleptic/sensory attributes, nutritional information, toxicology, sustainability, holistic information/practices (e.g., Ayurveda, etc.), molecular properties, etc.). Public and private research information (e.g., public data sources, food science research, lab analysis, bioinformatics initiatives, etc.) may be used and processed (e.g., data cleaning, data modelling, missing value handling, data normalization, encoding, categorization, aggregation, discretization, binning, etc.) for use by various machine learning techniques to determine the alternative plant-based substances.

Alternative plant-based substances are identified and scored at operations 330, 335. These operations may be performed by machine learning and other techniques as described below (e.g., clustering, classification, text mining, natural language processing (NLP), named entity recognition (NER), supervised and unsupervised machine learning models, decision trees, graph networks, reinforcement learning models, etc.). The scoring may be determined by various metrics and techniques as described below (e.g., optimization or partial optimization techniques, reinforcement learning, etc.).

Once the alternative plant-based substances have been identified by analysis module 120, the identified alternative plant-based substances are used in the formulation of the target food item (e.g., replaces the target ingredients in the target food item) to produce an alternative or modified food item that is tested, measured and validated in a lab or other setting at operation 340. When the alternative food item does not meet desired characteristics (e.g., for taste, feel or texture, functionality, etc.) as determined at operation 345, the process returns to operation 325 to identify other alternative plant-based substances for the target ingredients as described above. This provides a feedback or reinforcing loop based on prediction validation in the lab with error identification, measurement, and optimization. The feedback may be provided from computer or other systems performing the testing (or processing the results) to provide an automatic feedback loop to continuously update (or train) machine learning models for determination of the plant-based or other natural substances.

When the alternative food item satisfies the desired characteristics, a review of the characteristics is performed by an expert panel and/or a consumer panel at operation 350. When the desired characteristics are not satisfied as determined by the expert panel and/or consumer panel at operation 355, the process returns to operation 325 to identify other alternative plant-based substances for the target ingredients as described above. This provides a further feedback or reinforcing loop. The panel review may be conducted in-person and/or online via surveys, discussions, and/or other techniques. The feedback may be provided from computer or other systems performing the reviews (or processing the results) to provide an automatic feedback loop to continuously update (or train) machine learning models for determination of the plant-based or other natural substances.

When the alternative food item satisfies the desired characteristics as determined by the expert panel and/or consumer panel at operation 355, the process is complete and the alternative food item may be utilized at operation 360. In this case, the resulting plant-based or other natural substances are used to replace the (non-natural) target ingredients in the formulation of the target food item to produce an alternative or modified food item, preferably having all (or substantially all) ingredients being plant-based or natural.

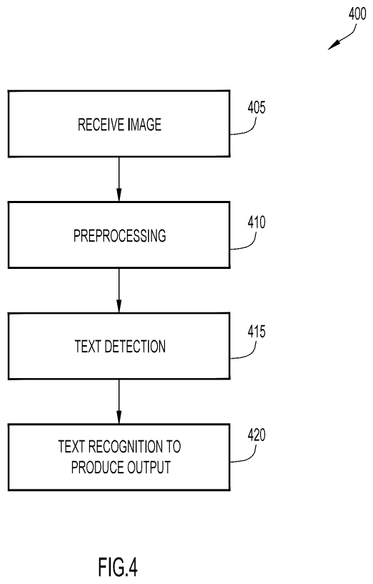

An example method 400 of collecting information for food items (e.g., via data collection module 116 and a server system 110 and/or client system 114) from a food item label according to an embodiment of the present invention is illustrated in FIG. 4. Method 400 may correspond to operation 305 of FIG. 3 and illustrates collection of information from an example data source (e.g., label) via conventional or other optical character recognition (OCR) and computer vision techniques. Initially, an image of a food item label is received at operation 405. The image may be captured by any suitable image capture device (e.g., a camera, etc.). The image is preprocessed at operation 410. This includes the detection of the outline of each character in the text of the label in the image, and can be achieved by any conventional or other neural network that can extract features from a two dimensional image (e.g., convolutional neural network (CNN), etc.)).

Text of the label is detected at operation 415. This includes generating bounding boxes around lines of text detected in the image by various conventional or other techniques (e.g., sliding window technique, region-based detectors, etc.). The text in the bounding boxes is recognized at operation 420 for correlation and storage (e.g., with data in database system 118). Multi-dimensional recurrent neural networks (RNNs) (e.g., bi-directional long short-term memory (LSTM), etc.) are implemented to find relations between the detected characters. The RNNs predict the location and values of the detected text characters. A transcription layer following the recurrent layers uses a probabilistic approach to decode the outputs of the LSTMs. Each frame generated by the LSTM is decoded into a character and these characters are fed into a final decoder/transcription layer which outputs the final predicted sequence.

In addition, various techniques (e.g., fuzzy matching, similarity profiling, etc.) may be used to find matches between ingredients already stored in database system 118 and the ingredients of the food product detected as texts. Accordingly, the food item label may provide information including ingredients, formulations, nutritional value, and composition.

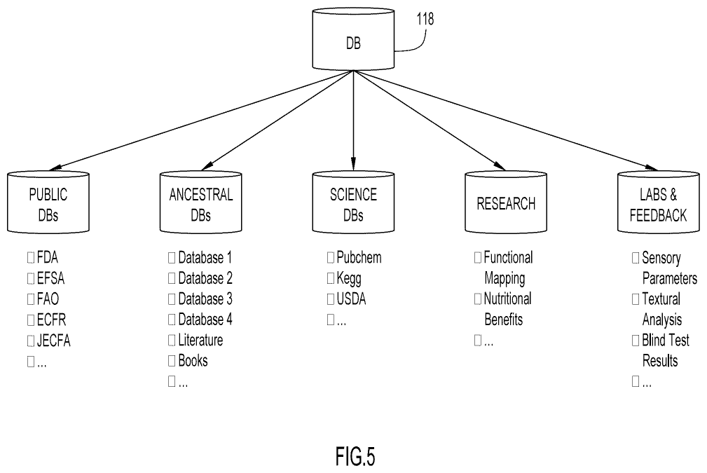

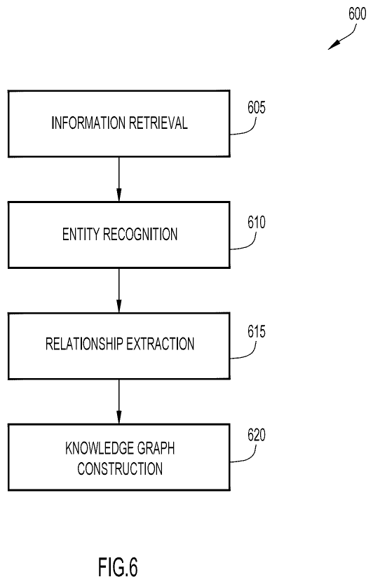

A method of collecting information for determining alternative plant-based or other natural substances (e.g., via data collection module 116 and a server system 110 and/or client system 114) according to an embodiment of the present invention is illustrated in FIGS. 5-6. The method may correspond to operation 305 of FIG. 3. Initially, database system 118 may receive information from various data sources, such as public databases 510 (e.g., FDA, EFSA, FAO, ECFR, JECFA, etc.), ancestral or holistic databases 515 (e.g., databases with literature or books, etc.), science databases 520 (e.g., Pubchem, Kegg, USDA, etc.), research databases 525 (e.g., with functional mapping, nutritional benefits, etc.), and databases storing lab and feedback 530 (e.g., sensory parameters, textural analysis, test results, etc.).

The information typically includes structured and unstructured information, where the unstructured information is processed according to method 600 as illustrated in FIG. 6. Initially, the information may be scraped and mined from the various data sources, where unstructured information is organized into a data-science friendly format. The ancestral or holistic information may be transcribed (e.g., translated, etc.) and recorded in database system 118.

Text mining is a process of acquiring meaningful insights and finding patterns from textual data that is not organized in a predefined manner (e.g., unstructured/raw data, etc.). The data collection involves a set of interdisciplinary approaches that include data mining, machine learning, natural language processing (NLP), statistics, etc. Text mining has application in the domain of food science since ingredient discoveries are often represented in the form of textual data in multiple scientific publications. Text mining has shown promising results with respect to ingredient discovery for a variety of food items. Latent information related to interactions between ingredients obtained through text mining can further enhance the possibility of finding new ingredients/combinations of ingredients.

Information pertaining to food items and/or plant-based substances is retrieved at operation 605. Data that is collected (e.g., from scientific journals, research papers, internet articles, etc.) and does not follow a defined format may be considered as unstructured data. This operation involves acquisition of relevant data from a database (e.g., database system 118) that is built on data which is collected from multiple sources (e.g., the internet, articles, research papers, books, etc. as described above for FIG. 5). For example, data crawling and information mining may be performed to extract structured data from unstructured/raw data. A data crawler searches for content related to previously recognized labels, while a data scraper forms queries to retrieve relevant data detected by the crawler. Queries are generated to retrieve data for a topic of interest (e.g., food, substance, etc.). Different types of queries may be generated (e.g., keywords with controlled vocabulary, Boolean search queries, natural language queries, wildcard queries, hybrid approaches, etc.). The resulting data may further be cleaned based on various techniques (e.g., decoding data, apostrophe lookup, removal of stop words, removal of punctuations, removal of expressions, splitting attached words, slang lookup, standardizing words, removal of URLs, grammar checking, spelling correction, etc.).

Named entity recognition (NER) is performed on the retrieved (or cleaned) data at operation 610 to locate specific entities in the retrieved text. NER basically extracts various entities (e.g., functionalities, properties, compounds, properties, etc.) from unstructured text. The extracted information is used to analyze relationships between entities. Various conventional or other techniques may be employed with respect to food entity recognition (e.g., dictionary look-up, rule-based approaches, machine learning, hybrid techniques, etc.). For example, the retrieved text may be segmented into sentences that are tokenized. The resulting tokens are tagged with a part of speech (e.g., by a part-of-speech (POS) tagger), where the tagged sentences are processed to identify the entities (e.g., dictionary look-up, rule-based approaches, machine learning, hybrid techniques, etc.).

Relationships between the determined entities in the retrieved data are extracted at operation 615. This operation detects relationships between extracted entities, and may employ any conventional or other techniques (e.g., techniques based on co-occurrence, techniques based on pattern recognition, rule-based approaches, etc.).

A knowledge graph is constructed at operation 620 based on the entities and relationships. This operation constructs a graphical representation of the extracted knowledge (e.g., associations between detected entities, etc.) which when linked can lead to the development of new hypotheses. The knowledge graph includes nodes that represent entities, a set of features associated with each node, and edges defining the relationships (e.g., unidirectional or bidirectional) between nodes. The knowledge graph may be used to identify associated entities (e.g., compounds and functionalities, etc.) for determining alternative plant-based substances.

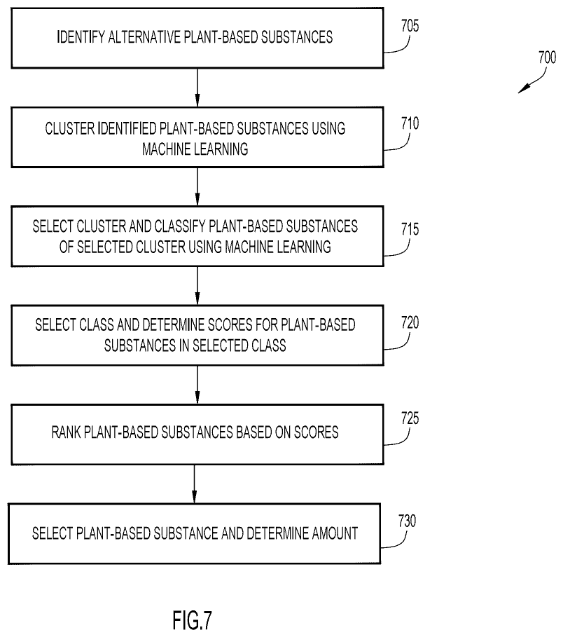

A method 700 of determining an alternative plant-based substance for a target food item (e.g., via analysis module 120 and a server system 110 and/or client system 114) according to an embodiment of the present invention is illustrated in FIG. 7. Initially, alternative plant-based substances for a target ingredient of a target food item are identified at operation 705. For example, properties (or profiles) of the target ingredient and plant-based substances in database system 118 may be compared to identify an initial set of plant-based substances. In addition, the knowledge graph may be used to identify plant-based substances based on the associations (e.g., functionalities (e.g., emulsifier, binder, thickening, preservation, etc.), properties, etc.).

The identified plant-based substances are clustered at operation 710 based on a desired objective or property (e.g., functionality, etc.). By way of example, an unsupervised machine learning model may be used to perform the clustering (e.g., K-means clustering K-means++, Fuzzy c-means clustering, hierarchical clustering, etc.). The model partitions unlabeled data points into a number of distinct clusters/groups based on patterns in the dataset.

The identified plant-based substances are clustered by the unsupervised machine learning model based on features (e.g., properties, etc.) of the plant-based substances. The elements or dimensions of a feature vector of the plant-based substances (and desired objective or functionality) define a feature space for the clustering. The features may include one or more from a group of: functionality information (e.g. emulsification, stabilization, gelling properties, fat replacement properties, etc.); physicochemical characteristics (e.g. pH, viscosity, moisture, density, etc.); mechanical properties (e.g. adhesive strength, tensile strength, shear resistance, etc.); chemical and molecular descriptors (e.g., bioactive compounds, molecular structure, phytonutrients, etc.); sensorial characteristics (e.g., taste, smell, color, texture, mouthfeel, etc.); nutritional information (e.g., macro/micronutrients, etc.); taxonomical information; bioactive compounds; and ancestral wisdom (e.g., Ayurvedic, etc.). In addition, the features may include information from the knowledge graph (e.g., associations, etc.).

The unsupervised machine learning model performs cluster analysis to group plant-based substance data that has not been labeled, classified, or categorized. The cluster analysis identifies common characteristics in the plant-based substance data. The unsupervised machine learning model clusters the plant-based substances in the feature space to form clusters of plant-based substances by processing the feature vector of the plant-based substances. The formed clusters are preferably each associated with a level of the functionality or other objective (e.g., high level of emulsification, etc.). The objective may pertain to any desired characteristic or requirement (e.g., taste, feel or texture, functionality, etc.) of the target ingredient for which the plant-based substance should approximate or comply. The clustering may be performed to produce any quantity of clusters.

The unsupervised machine learning model may be implemented by any conventional or other machine learning models (e.g., mathematical/statistical models, classifiers, feed-forward, recurrent or other neural networks, etc.). For example, neural networks may include an input layer, one or more intermediate layers (e.g., including any hidden layers), and an output layer. Each layer includes one or more neurons, where the input layer neurons receive input (e.g., feature vectors), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the unsupervised machine learning model may be trained with a training set of unlabeled features and/or new input features (e.g., the features of the feature vectors described above), where the neural network attempts to produce the provided data and uses an error from the output (e.g., difference between inputs and outputs) to adjust weight (and bias) values. The output layer of the neural network indicates a cluster for input data. By way of example, the output layer neurons may indicate a specific cluster or an identifier of the specific cluster. Further, output layer neurons may be associated with different clusters and indicate a probability of the input data belonging to the associated cluster. The cluster associated with the highest probability is preferably selected for the input data.

By way of example, the clustering may be performed based on an emulsifier functionality. In this example case, an unlabeled dataset includes the various identified plant-based substances and the clusters are groups of emulsifiers that show various levels of emulsification (e.g., high level, medium level, low level, etc.). The different features, parameters, or independent variables (e.g., pH, HLB score, apparent viscosity, freezing point, etc.) determine the varying degrees of emulsification, and the clustering distinguishes plant-based substances exhibiting similar feature/parameter values from others by grouping them into specific clusters of emulsifiers. The plant-based substances of a particular cluster may be used to discover/manufacture a specific type of emulsifier which varies from another emulsifier made from plant-based substances belonging to another cluster of emulsifiers.

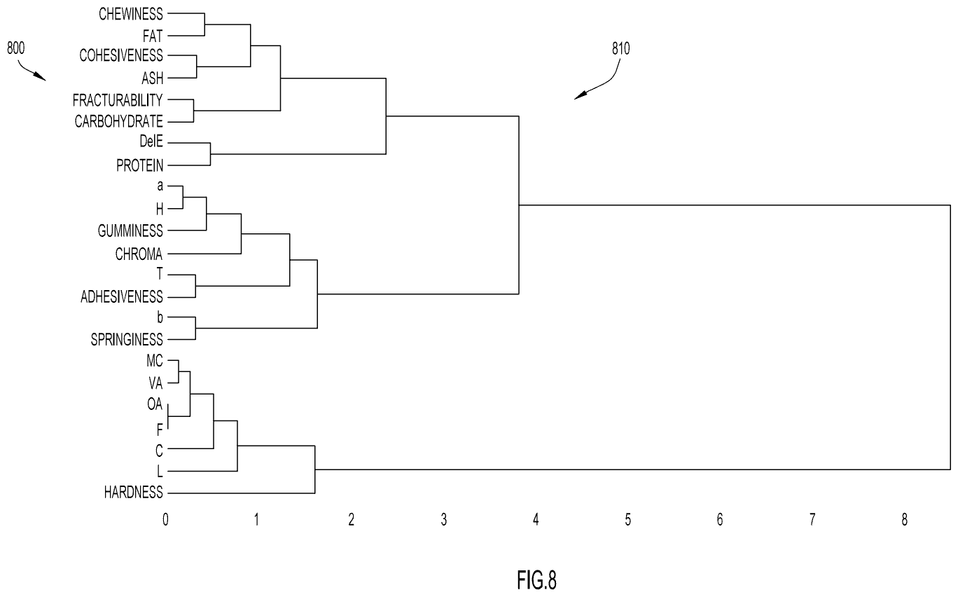

By way of further example with respect to FIG. 8, hierarchical clustering may be employed to cluster plant-based substances with respect to an emulsifier functionality. In hierarchical clustering, each data point is initially considered a separate cluster, where a pair of nearest individual clusters is merged. At every iteration, a few clusters merge or fuse to form a bigger cluster, and this process is repeated until a single cluster is formed. Clusters are merged based on similarity values that determine closeness of two clusters. Similarities between clusters can be obtained through various conventional or other techniques. For example, a single linkage technique determines similarity based on a minimum Euclidean distance between two data points belonging to two different clusters. A complete linkage technique determines similarity based on a maximum Euclidean distance between two data points belonging to two different clusters. In addition, an average linkage technique determines similarity based on an average of the Euclidean distances between all the pairs of data points of two different clusters.

As represented in dendrogram 800, various features may affect the formation of the clusters (e.g., MC, VA, OA, chewiness, gumminess, carbohydrate, protein, fat, hardness, springiness, etc.). The plant-based substances having similar feature values are grouped to form the clusters. For example, clusters 810 are derived from plant-based substances having similar values for features including chewiness, gumminess, carbohydrate, hardness, etc.

Referring again to FIG. 7, a cluster of plant-based substances is selected at operation 715, and the plant-based substances of the cluster are classified into corresponding classes. Evaluation metrics are used to evaluate the quality of clusters (e.g., of different emulsifiers, etc.), especially when a large number of independent variables/features are involved (e.g., with respect to each of the types of emulsifiers). By way of example, metrics including inertia and Dunn index may be employed to determine compactness of the clusters for selection. Inertia measures intra-cluster distances, while the Dunn index measures inter-cluster distances. A cluster with a lower (or lowest) value of inertia and a higher (or highest) value of the Dunn index indicates an acceptable cluster for selection. The inertia and Dunn index may be combined (e.g., summed, averaged, difference, etc.) in any fashion to determine a score for selecting a cluster (e.g. greatest difference, etc.). A cluster is selected with appropriate metrics and corresponding to the desired objective or functionality. Referring to the above emulsification example, a cluster corresponding to the desired level of emulsification (e.g., high level, medium level, low level, etc.) and having desired or sufficient metrics (e.g., lower value of inertia and a higher value of the Dunn index) may be selected.

Cluster profiling may be performed in order to gain insights for effective decision making with respect to plant-based substances (e.g., the choice of an emulsifier that could be used to imitate the emulsifier present in the target food item (e.g. non-dairy plant only ice cream)).

Plant-based substances within the selected cluster are classified into corresponding classes by a machine learning or other classifier. By way of example, the classes may correspond to a level of fitness for achieving the functionality or objective (e.g., a class associated with a good fit for the objective, a class associated with an average fit for the objective, a class associated with a poor fit for the objective, etc.). Classification employs a supervised machine learning model that segregates data points into classes based on similarity between features of the data points and features/variables defining each one of the classes or categories. For example, a classification approach to emulsification properties that are obtained through clustering aides in predicting a best fit for an emulsifier from the classes or categories of emulsifiers.

The supervised machine learning model may be implemented by any conventional or other machine learning models (e.g., mathematical/statistical models, classifiers, feed-forward, recurrent or other neural networks, etc.). For example, neural networks may include an input layer, one or more intermediate layers (e.g., including any hidden layers), and an output layer. Each layer includes one or more neurons, where the input layer neurons receive input (e.g., feature vectors), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the supervised machine learning may be performed with feature vectors (of plant-based substances, such as the features of the feature vectors described above for clustering) of the training set as input and corresponding known classes as outputs, where the neural network attempts to produce the provided output (or class) and uses an error from the output (e.g., difference between produced and known outputs) to adjust weight (and bias) values (e.g., via backpropagation or other training techniques). The output layer of the neural network indicates a class for input data. By way of example, the output layer neurons may indicate a specific class or an identifier of the specific class. Further, output layer neurons may be associated with different classes and indicate a probability of the input data belonging to the associated class. The class associated with the highest probability is preferably selected for the input data.

The clusters resulting from unsupervised training may be used to provide new features to train the classifier machine learning model. The performance of the classifier machine learning model may be boosted when an unsupervised learning algorithm (e.g., clustering, etc.) is followed by supervised training with various classifier models (e.g., logistic regression, random forests, gradient, etc.).

A cross validation technique may assess the efficiency of a classification model. An entire dataset is split into two subsets, including a training set and validation set. During each iteration, the classification model is trained with the training set, and the validation set is used to measure the accuracy of the model based on various metrics (e.g., sensitivity, specificity, accuracy, etc.).

Once the plant-based substances of the selected cluster are classified, a class corresponding to a sufficient level of fitness for the desired objective or functionality is selected (e.g., highest fitness, etc.) at operation 720, and a score is determined for each plant-based substance in the selected class in order to identify the resulting plant-based substance. The score may be determined based on various numerical metrics that may be weighted and combined to produce the score (e.g., nutritional content, compounds, health scores, etc.). A non-numerical value for a metric may be converted to a numerical value and used for determining the score. The weights may be assigned based on the objective or functionality to provide appropriate influence of the metrics. Further, the score may be optimized to indicate a best selection based on various metrics (e.g., curve fitting approach, etc.).

The plant-based substances are ranked based on the scores at operation 725, and a resulting plant-based substance is selected based on the score or ranking at operation 730 (e.g., the highest ranked plant-based substance, the plant-based substance with the highest score, etc.). In addition, the amount of the selected plant-based substance to use in the formulation for the target food item is determined based on a mapping of benchmark data points of the ingredient of the target food item being replaced.

The amount of the plant-based substance is based on rules providing conditions. For example, rules may indicate organoleptic properties shouldn't change, based on comparing data points with benchmark product; nutritional properties should be enhanced based on comparing data points with the benchmark product; and/or ingredients should be compatible with each other.

In the event, plural target ingredients of a target food item are desired to be replaced by plant-based or other natural substances, the above process may be repeated to determine a plant-based or other natural substance for each target ingredient in substantially the same manner described above. In addition, an embodiment of the present invention may select two or more plant-based substances from a selected class based on the scores and/or rankings, where the combination of the two or more plant-based substances may be used in place of the target ingredient to produce a modified food item in substantially the same manner described above. A plant-based substance may include any substance originating, or derived from, a plant, preferably a natural substance occurring in nature and without artificial components.

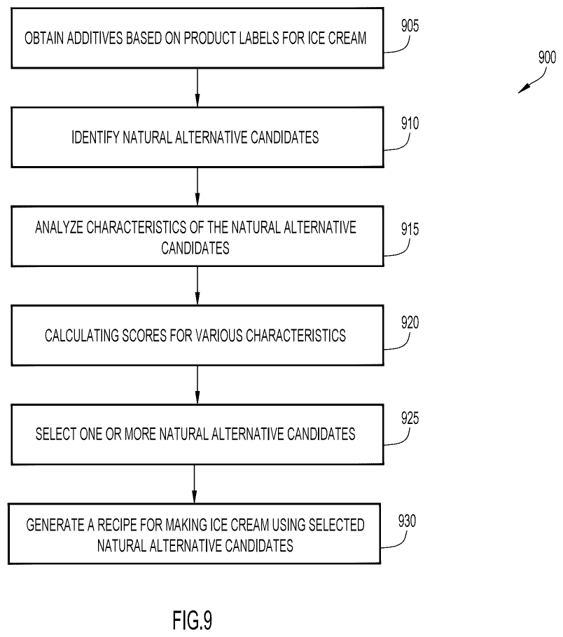

By way of example, an embodiment for generating a recipe for making ice cream using selected alternative plant-based substances for ice cream to replace synthetic (or non-natural) ingredients of the ice cream is illustrated in an example method 900 of FIG. 9.

In operation 905, standard industry formulations and product labels are captured and recognized so as to obtain various additives and ingredients for ice cream. For example, product labels may be reviewed for information about additives and ingredients, and the information may be manually entered into a digital file for use by the system. Alternatively, a digital image of a product label may be obtained with a camera and optical character recognition (OCR) may be used to extract text from the product label, as explained above, which may then be analyzed to identify additives and ingredients listed on the product label. In another alternative embodiment, information about the additives and ingredients in a product may be obtained by searching online sources, such as a manufacturer's website.

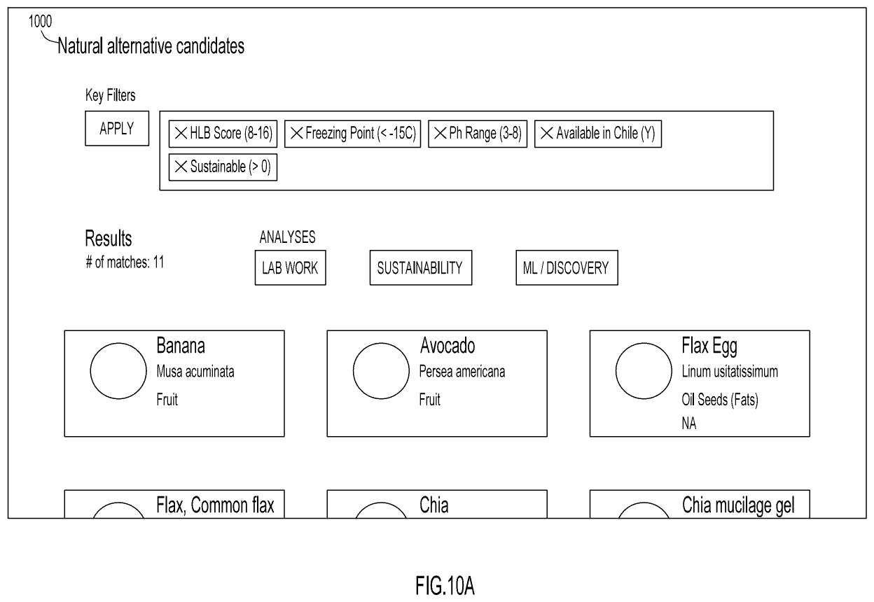

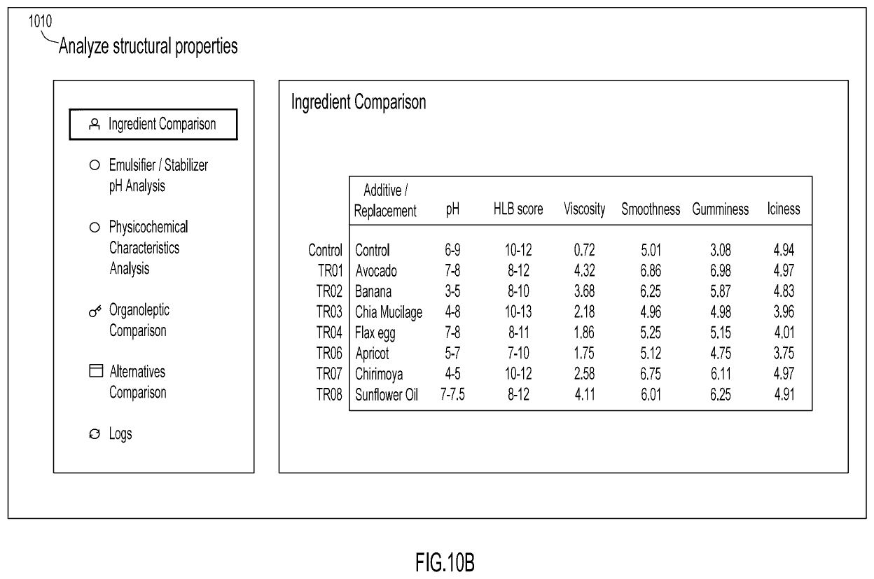

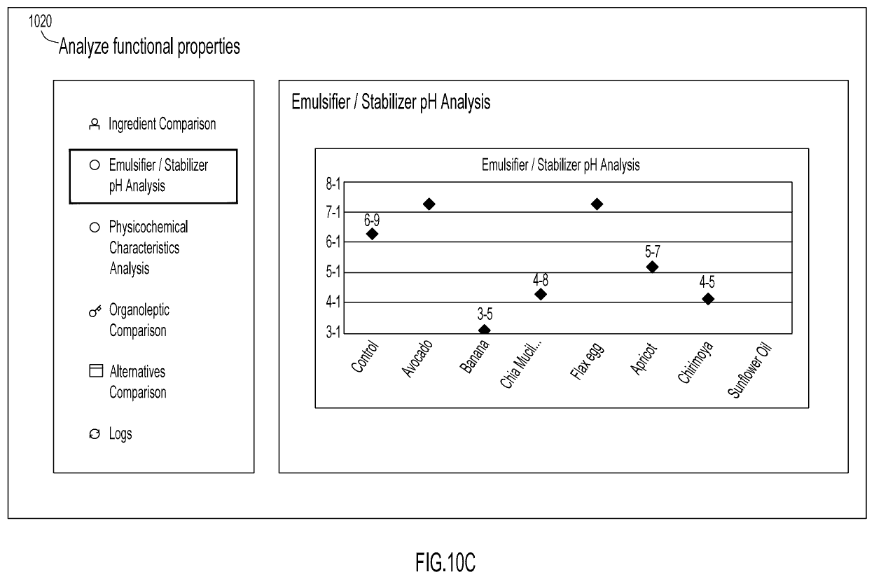

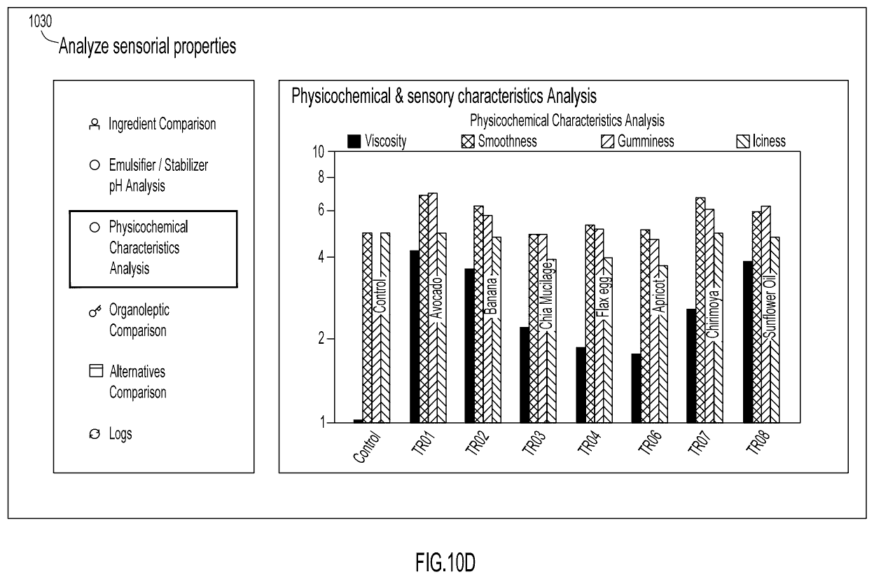

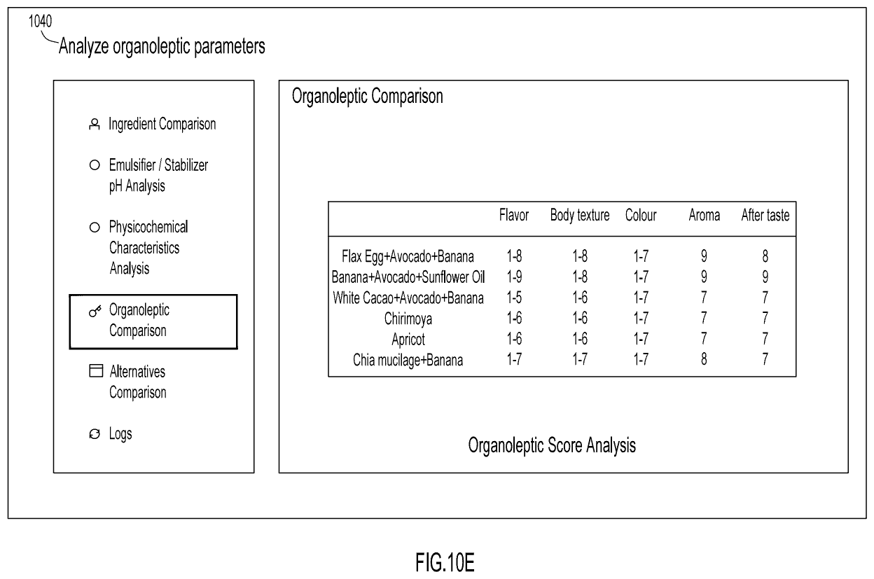

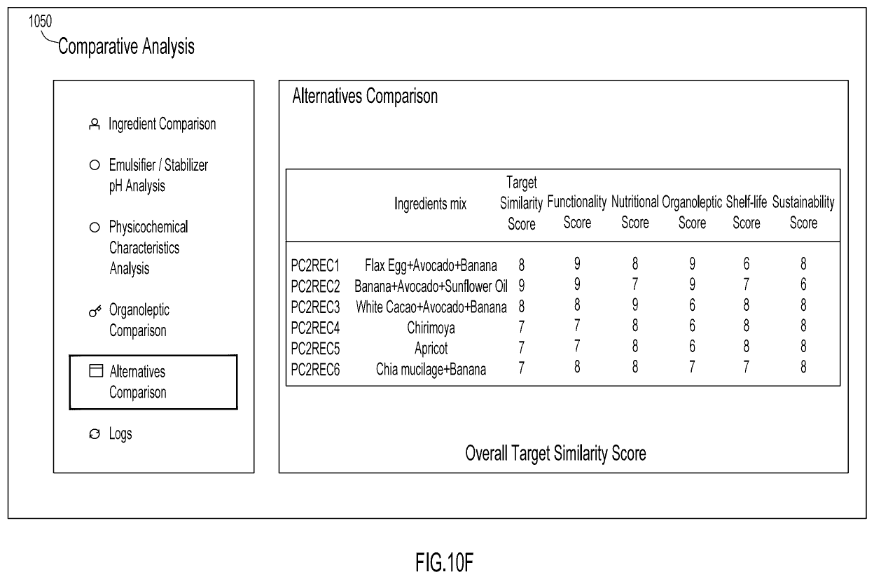

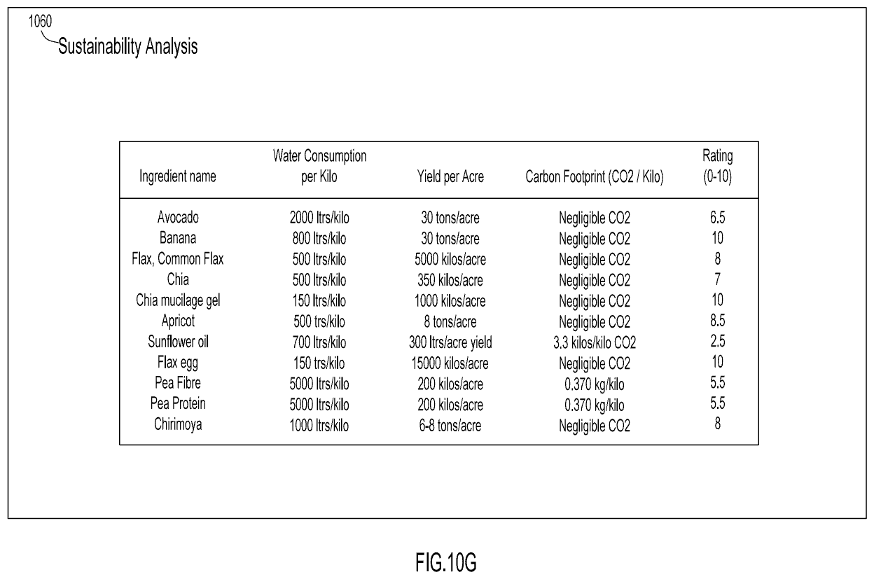

In operation 910, using information in a knowledge base (e.g., DB 118 of FIG. 5), natural alternative candidates are identified. Natural alternative candidates are identified based on analyzing the information in a knowledge base using desired properties, local availability, and/or sustainability. As an example, natural alternative candidates 1000 may include banana, avocado, flax egg, okra, colocasia root, apricot, and so on, as illustrated in FIG. 10A.

Referring again to FIG. 9, in operation 915, characteristics of the identified natural alternative candidates are analyzed to determine whether they are suitable alternatives. Specifically, characteristics may include various ingredients or key parameters being analyzed and compared to one another to determine whether it is a suitable natural alternative, as illustrated in a view 1010 of FIG. 10B. Some key parameters may include pH, viscosity, HLB (hydrophilic-lipophilic balance) score, smoothness, gumminess, and/or iciness. Characteristics may further include functional properties of the suitable natural alternatives, as illustrated in a view 1020 of FIG. 10C. For example, functional properties may include emulsifier and/or stabilizer pH analysis to achieve protein stability and to establish a ratio of non-fat solids in a mix to increase the pH and lower the acidity. Characteristics may include sensorial properties of suitable natural alternatives, as illustrated in a view 1030 of FIG. 10D. Sensorial properties may include hardness, creaminess, chewiness, gumminess, and/or iciness. Characteristics may further include physicochemical attributes such as size of ice crystals, viscosity, and/or freezing. Further, the operation 915 of analyzing characteristics of the natural alternative candidates may include an organoleptic comparison, as illustrated in the view 1040 of FIG. 10E. Organoleptic parameters may include flavor, texture, aroma, and/or aftertaste.

In operation 920, the method 900 includes calculating scores for various parameters/characteristics of candidate mixes considered i.e., performing comparative analysis of various mixes, as illustrated in a view 1050 of FIG. 10F. Example techniques for calculating the scores were explained in operation 335 of FIG. 3. The score may be determined based on various numerical metrics that may be weighted and combined to produce the score (e.g., nutritional content, compounds, health scores, etc.). A non-numerical value for a metric may be converted to a numerical value and used for determining the score. The weights may be assigned based on the objective or functionality to provide appropriate influence of the metrics. Further, the score may be optimized to indicate a best selection based on various metrics (e.g., curve fitting approach, etc.). Scoring may be based on a presence of compounds that provide desired functionalities. Compounds may be ranked based on presence of each of the desired molecular subclasses that represents scoring priority while testing them in a product formulation.

Additionally, various logs may be analyzed based on laboratory testing, for example. Laboratory testing may yield various results such as banana and avocado oxidize and need natural acidic carrier like lemon juice, candidate B works better than candidate C but is x % costlier, and/or ingredient D has y % better shelf life. Also, sustainability is examined, as illustrated in a view 1060 of FIG. 10G.

In operation 925 of the method 900 of FIG. 9, one or more of the natural alternative candidates are selected and in operation 930, a recipe (instructions) for making ice cream using the selected natural alternatives instead of synthetic additives is generated. The ice cream may then be produced based on the generated recipe. For example, the recipe may be programmed into an automation system configured to manufacture a food product such as ice cream. This is provided by way of an example only and not by way of a limitation.

Present invention embodiments provide several technical and other advantages. For example, present invention embodiments are very exhaustive and driven by data and machine learning and other algorithms. This enables a higher number of ingredient combinations to be considered for developing a product while reducing resources and costs. Observations in traditional approaches are derived primarily by testing in the lab and through discussions and research. Present invention embodiments apply data captured for analysis to machine learning and other algorithms to create innovative combinations of ingredients for further validation through physical lab testing. As a result, present invention embodiments remove unviable combinations through scoring by identifying and discarding options even before they are tested in a lab. This conserves computational and memory resources by processing fewer data items and reduces costs.

In addition, innovative combinations are created as a result of applying machine learning and other algorithms to captured data. These combinations are based on an evolving and optimizing function to deliver certain functionalities and properties. For example, the machine learning models (e.g., for clustering, classification, etc.) may be continuously updated (or trained) based on feedback from the lab testing and/or expert/consumer panel reviews. The feedback may be provided from computer or other systems performing the testing and/or reviews (or processing the results) to provide an automatic feedback loop for determination of the plant-based or other natural substances. Thus, the machine learning models (e.g., for clustering, classification, etc.) may continuously evolve (or be trained) to learn further attributes for determination of the plant-based or other natural substances. The resulting plant-based or other natural substances are used to replace (non-natural) ingredients in the formulation of the target food item and produce an alternative or modified food item, preferably having all (or substantially all) ingredients being plant-based or natural.

It will be appreciated that the embodiments described above and illustrated in the drawings represent only a few of the many ways of implementing embodiments for a system and method for identifying natural alternatives to synthetic additives in foods.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available software (e.g., browser software, communications software, server software, etc.) and software of present invention embodiments (e.g., data collection module 116, analysis module 120, etc.). These systems may include any types of monitors and input devices (e.g., keyboard, mouse, voice recognition, etc.) to enter and/or view information.

It is to be understood that the software (e.g., data collection module 116, analysis module 120, etc.) of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., data collection module 116, analysis module 120, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., requests, alternative substance, amounts, properties, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., plant-based substances, properties, etc.).

The present invention embodiments are not limited to the specific tasks or algorithms described above, but may be utilized for food or any other items (e.g., cosmetics, fragrances, healthcare, etc.) that may utilize plant-based or other natural substances.

It will be appreciated that the example embodiments described above and illustrated in the accompanying drawings represent only a few of the many ways of implementing the invention. Various modifications of the invention in addition to those shown and described herein will be apparent to those skilled in the art from the foregoing description. Such modifications are intended to fall within the scope of the appended claims.

What is claimed is:

1. A method of modifying a food item to contain plant-based ingredients comprising the steps of:
identifying, via a computer, plant-based substances to replace an ingredient of the food item, wherein identifying plant-based substances to replace an ingredient of the food item comprises constructing a knowledge graph that includes nodes representing plant-based substances, a set of features associated with each node, and edges defining relationships between the nodes; clustering the plant-based substances, via a machine learning model on a computer, into a plurality of clusters according to a desired objective and based on features of the plant based substances; classifying, via a machine learning classifier on a computer, the plant-based substances of a selected cluster into a plurality of classes based on the desired objective and the features of the plant-based substances of the selected cluster; determining, via a computer, a score for each plant-based substance of a selected class based on metrics; and determining, via a computer, a plant-based substance based on the score to produce a modified food item with the determined plant-based substance replacing the ingredient.

2. The method of claim 1, wherein the set of features associated with each node of the knowledge graph comprise respective functionalities of the plant-based substances.

3. The method of claim 1, wherein the features of the plant-based substances used in the clustering step comprise features from the knowledge graph.

4. The method of claim 1, wherein the features of the plant-based substances used in the clustering step comprise one or more selected from the group consisting of functionality, physicochemical characteristics, mechanical properties, chemical and molecular descriptors, sensorial characteristics, nutritional information, taxonomical information, bioactivity, and attributes from ancestral wisdom.

5. The method of claim 1, wherein each cluster in the plurality of clusters is associated with a level of the desired objective.

6. The method of claim 5, wherein the desired objective comprises a functionality of the ingredient to be replaced.

7. The method of claim 1, wherein the machine learning model used in the clustering step comprises an unsupervised machine learning model trained with a set of features associated with plant-based substances as an input.

8. The method of claim 1, wherein the classes correspond to a level of fitness for achieving the desired objective.

9. The method of claim 1, wherein the machine learning classifier used in the classifying step comprises a supervised machine learning classifier trained using feature vectors of the plant-based substances as an input and known classes as an output.

10. The method of claim 9, wherein the machine learning classifier is trained with new features from clusters resulting from unsupervised operation of the machine learning model.

11. The method of claim 1, further comprising calculating the metrics based on the properties of the plant-based substances meeting the desired objective.

12. The method of claim 1, wherein the features of the plant-based substances for the machine learning model comprise attributes of the plant-based substances obtained from ancestral wisdom.
The method of claim 1, further comprising:

13. producing the modified food item by replacing the ingredient with the determined plant-based substance; testing the modified food item with respect to characteristics for the food item; obtaining feedback in response to the modified food item failing to satisfy the characteristics for the food item; and training at least one of the machine learning model and the machine learning classifier using the feedback.

14. A system for modifying a food item to contain plant-based ingredients, the system comprising:
one or more memories; and at least one processor coupled to the one or more memories, the at least one processor configured to:
identify plant-based substances to replace an ingredient of the food item, wherein the at least one processor is configured to identify plant-based substances to replace an ingredient of the food item by constructing a knowledge graph that includes nodes representing plant based substances, a set of features associated with each node, and edges defining relationships between the nodes; cluster, via a machine learning model, the plant-based substances into a plurality of clusters according to a desired objective based on features of the plant-based substances; classify, via a machine learning classifier, the plant-based substances of a selected cluster into a plurality of classes based on the desired objective and the features of the plant based substances of the selected cluster; determine a score for each plant-based substance of a selected class based on metrics; and determine a plant-based substance based on the score to produce a modified food item with the determined plant-based substance replacing the ingredient

15. The system of claim 14, wherein the set of features associated with each node of the knowledge graph comprises respective functionalities of the plant-based substances.

16. The system of claim 14, wherein the features of the plant-based substances used in the clustering step comprises features from the knowledge graph.

17. The system of claim 14, wherein the features of the plant-based substances used by the at least one processor to cluster comprise one or more selected from the group consisting of functionality, physicochemical characteristics, mechanical properties, chemical and molecular descriptors, sensorial characteristics, nutritional information, taxonomical information, bioactivity, and attributes from ancestral wisdom.

18. The system of claim 14, wherein each cluster in the plurality of clusters is associated with a level of the desired objective.

19. The system of claim 18, wherein the desired objective comprises a functionality of the ingredient to be replaced.

20. The system of claim 14, wherein the machine learning model is an unsupervised machine learning model trained with a set of features associated with plant-based substances as an input.

21. The system of claim 14, wherein the classes correspond to a level of fitness for achieving the desired objective.

22. The system of claim 14, wherein the machine learning classifier comprises a supervised machine learning classifier trained using feature vectors of the plant-based substances as an input and known classes as an output.

23. The system of claim 22, wherein the machine learning classifier is trained with new features from clusters resulting from unsupervised operation of the machine learning model.

24. The system of claim 14, wherein the at least one processor is further configured to calculate the metrics based on the properties of the plant-based substances meeting the desired objective.

25. The system of claim 14, wherein the features of the plant-based substances for the machine learning model comprise attributes obtained from ancestral wisdom.

26. A computer program product for modifying a food item to contain plant-based ingredients, the computer program product comprising one or more computer readable media having instructions stored thereon, the instructions executable by at least one processor to cause the at least one processor to:
identify plant-based substances to replace an ingredient of the food item, wherein the instructions stored on the one or more computer readable media are executable by the at least one processor to cause the at least one processor to identify plant-based substances to replace an ingredient of the food item by constructing a knowledge graph that includes nodes representing plant-based substances, a set of features associated with each node, and edges defining relationships between the nodes; cluster the plant-based substances, via a machine learning model, into a plurality of clusters according to a desired objective based on features of the plant-based substances; classify, via a machine learning classifier, the plant-based substances of a selected cluster into a plurality of classes based on the desired objective and the features of the plant based substances of the selected cluster; determine a score for each plant-based substance of a selected class based on metrics; and determine a plant-based substance based on the score to produce a modified food item with the determined plant-based substance replacing the ingredient.

27. The computer program product of claim 26, wherein the set of features associated with each node of the knowledge graph comprises respective functionalities of the plant-based substances.

28. The computer program product of claim 26, wherein the features of the plant-based substances used in the clustering step comprise features from the knowledge graph.

29. The computer program product of claim 26, wherein the features of the plant-based substances used by the at least one processor to cluster comprise one or more selected from the group consisting of functionality, physicochemical characteristics, mechanical properties, chemical and molecular descriptors, sensorial characteristics, nutritional information, taxonomical information, bioactivity, and attributes from ancestral wisdom.

30. The computer program product of claim 26, wherein each cluster in the plurality of clusters is associated with a level of the desired objective.

31. The computer program product of claim 30, wherein the desired objective comprises a functionality of the ingredient to be replaced.

32. The computer program product of claim 26, wherein the machine learning model comprises an unsupervised machine learning model trained with a set of features associated with plant-based substances as an input.

33. The computer program product of claim 26, wherein the classes correspond to a level of fitness for achieving the desired objective.

34. The computer program product of claim 26, wherein the machine learning classifier comprises a supervised machine learning classifier trained using feature vectors of the plant-based substances as an input and known classes as an output.

35. The computer program product of claim 34, wherein the machine learning classifier is trained with new features from clusters resulting from unsupervised operation of the machine learning model.

36. The computer program product of claim 26, wherein the instructions stored on the one or more computer readable media are executable by the at least one processor to cause the at least one processor to calculate the metrics based on the properties of the plant-based substances meeting the desired objective.

37. The computer program product of claim 26, wherein the features of the plant-based substances for the machine learning model comprise attributes obtained from ancestral wisdom.
